(19) United States
(12) Patent Application Publication
(10) Pub. No.: US 2013/0084361 A1
(43) Pub. Date: Apr. 4, 2013

(54) VEGAN SIMULATED EGG COMPOSITIONS AND METHODS

(71) Applicant: Rockney A. Shepheard, (US)

(72) Inventor: Rockney A. Shepheard, (US)

(21) Appl. No.: 13/248,425

(22) Filed: Sep. 29, 2011

(51) Int. Cl. A23J 1/18; A23L 1/302; A23L 1/28; A23L 1/05; A23J 3/20; A23L 1/054; A23L 1/0534; A23L 1/0526; A23L 1/275; A23L 1/305; A23L 1/0532

(52) U.S. Cl. 426/62; 426/531; 426/72; 426/61; 426/573; 426/575

(57) ABSTRACT

The present invention relates to compositions and methods for preparation of vegan simulated egg yolks, simulated egg whites, and simulated whole eggs consisting of the vegan simulated egg yolk and egg white compositions, for consumption. The compositions simulate sensorily an animal-derived egg, such as a chicken egg, and may have the same protein and vitamin content.

### FIELD OF THE INVENTION

This invention generally relates to the field of production of vegan simulated egg compositions for consumption and methods for preparing the vegan simulated egg compositions. More specifically, this invention relates to vegan simulated egg whites, vegan simulated egg yolks and vegan simulated whole egg compositions having taste, texture, aroma and mouth-feel properties similar to cooked egg products using eggs derived from animals.

### BACKGROUND OF THE INVENTION

Veganism is the practice of eliminating animal exploitation including human consumption of animal-derived products. The term “vegan” was used in England in 1944 by Donald Watson, co-founder of the British Vegan Society, to mean “non-dairy vegetarian.” The Society also opposed the use of eggs as food. The definition of vegan was expanded in 1951 to mean “the doctrine that man should live without exploiting animals.” In 1960, H. Jay Dinshah founded the American Vegan Society, linking veganism to the Jainist concept of ahimsa, the avoidance of violence against living things. Veganism is growing as a movement worldwide. The number of vegan restaurants is increasing. The benefits of a well-planned vegan diet include reduced risk of several disease conditions, including heart disease and cancer.

Although various modified egg products and egg “substitutions” exist, such as Eggbeaters®, these products contain egg derivatives and/or animal products and are not “vegan.” Though these products are beneficial, they fail to satisfy the “taste, feel and appearance” of real egg products. The demand for egg replacement products is on the rise, including people with egg allergies, people wishing to limit cholesterol intake, vegetarians and vegans and people of certain religious beliefs.

There are very few egg replacement products in the marketplace that are completely vegan, and those are typically used to substitute for eggs in baked products. An example is Ener-G Egg Replacer®, Ener-G Foods, Inc., Seattle, Washington, a powdered egg replacer, which contains potato starch, tapioca starch flour, leavening (calcium lactate), calcium carbonate, citric acid, sodium carboxymethylcellulose and methylcellulose, and is used “strictly in baking” to replace eggs (www.ener-g.com).

There remains a need for vegan simulated egg compositions, particularly simulated whole egg compositions that mimic, visually and sensorily, animal-derived eggs, especially chicken eggs, including fried eggs.

### SUMMARY OF THE INVENTION

Accordingly, the present invention is directed to vegan simulated egg compositions for consumption and to methods of making such compositions. The present invention provides vegan simulated egg compositions having the sensory properties of an animal-derived egg, such as a chicken's egg, and, optionally, having the approximate vitamin and protein content of an animal-derived egg. The compositions of the invention include a vegan simulated egg yolk, vegan simulated egg white and a vegan simulated whole egg composition consisting of a combination of the vegan simulated egg yolk and egg white. The simulated egg yolk compositions include water, a fungi derivative, a thickening agent, a salt and a coloring agent. The simulated egg white compositions include a non-animal protein-based solid, a fungi derivative, a salt, and a thickening agent. The methods of the invention include preparing a whole egg composition by joining the simulated egg white and simulated egg yolk.

The details of one or more embodiments are set forth in the accompanying drawings and the description below. Other features and advantages will be apparent from the description and drawings and from the claims.

### BRIEF DESCRIPTION OF THE DRAWINGS

FIG. 1 is a photograph of a vegan whole fried egg composition of the invention.

FIG. 2 is a photograph of blueberry pancakes prepared using the vegan egg yolk composition of the invention to replace chicken-derived eggs in the recipe.

FIG. 3 is a photograph of french toast prepared using the vegan egg yolk composition of the invention to replace chicken-derived eggs in the recipe.

FIG. 4 is a photograph of scrambled eggs prepared using the vegan egg white composition of the invention and the vegan egg yolk composition of the invention.

FIG. 5 is a photograph of a salad dressing prepared using the vegan egg yolk composition of the invention to replace chicken-derived eggs in the recipe.

FIG. 6 is a photograph of a vegan deviled egg prepared using the vegan egg white composition of the invention and the vegan egg yolk composition of the invention.

FIG. 7 is a photograph of a vegan omelette prepared using the vegan egg white composition of the invention to replace chicken-derived eggs in the recipe.

### DETAILED DESCRIPTION OF THE INVENTION

The present invention provides vegan simulated egg compositions having the sensory properties of an animal-derived egg, such as a chicken egg, and optionally, having the approximate vitamin and protein content of a chicken-derived egg yolk, egg white and whole egg. The invention includes methods for the preparation of the compositions of the invention, including a vegan simulated egg yolk, a vegan simulated egg white and a vegan simulated whole egg composition consisting of the vegan egg yolk and vegan egg white, that may be joined together.

The compositions of the invention may be stored separately (as vegan egg yolk or egg white), or together, for example by refrigeration or freezing, using synthetic plastic wraps, bags or other containers or by vacuum sealing means. The compositions may be heated before consumption using conventional methods, including heating in a microwave, convection oven or stovetop. A vegan oil or margarine may be used to enhance cooking The shelf life of the uncooked simulated egg compositions of the invention is estimated to be several days unrefrigerated, because they contain no animal products and thus may be less vulnerable to bacteria. However, it is recommended to keep these compositions refrigerated or frozen.

Generally, the ingredients incorporated into the vegan simulated egg yolk compositions of the invention comprise water, a fungi derivative, a thickener, a salt and a coloring agent. These ingredients are readily available, for example in grocery stores, health food stores and on the internet.

A preferred fungi derivative for use in the vegan simulated egg yolk compositions of the invention is nutritional yeast flakes prepared from deactivated yeast, usually Saccharomyces cerevisiae. The yeast flakes are a source of vitamins and are a complete protein. The vegan whole egg compositions of the invention can be prepared to contain approximately the same protein and vitamin content of a chicken-derived egg. Alternatively, the compositions can be prepared to contain more or less protein or vitamins, as desired by altering the amount of protein or vitamin content of the existing ingredients, or by adding supplementary sources of vegan protein or vitamins.

A preferred thickener for use in the vegan simulated egg yolk compositions of the invention is sodium alginate, the salt of alginic acid, which is extracted from the cell walls of brown algae and has a gummy texture.

A preferred salt for use in the vegan simulated egg yolk compositions of the invention is a rock salt, such as Kala Namak, an Indian mineral salt.

A preferred coloring agent for use in the vegan simulated egg yolk composition of the invention is beta carotene, because it mimics the color of animal-derived egg yolks. Beta carotene is an intensely, yellow-orange-colored pigment obtained from plants and fruits.

Generally, the ingredients incorporated into the vegan simulated egg white compositions of the invention comprise a fungi derivative, a non-animal derived solid, a thickener, and a salt. These ingredients are readily available, for example in grocery stores, health food stores and on the internet.

A preferred fungi derivative for use in the vegan simulated egg white compositions of the invention is nutritional yeast flakes.

A preferred non animal-derived solid for use in the vegan simulated egg white compositions of the invention is a legume-based solid, such as tofu processed from soybeans. Other non-animal derived sources of vitamins and protein may be used, for example chick peas and canellini beans.

A preferred thickener for use in the vegan simulated egg white compositions of the invention is konjac flour, obtained from the tubers of species of the Amorphophallus plant. Konjac flour is a soluble dietary fiber similar to pectin in structure and function, and consists mainly of a hydrocolloidal polysaccharide, glucomannan. Other vegan food thickeners suitable for human consumption., may be used in place of konjac flour, including but not limited to: xanthum gum, carrageenan, methylcellulose, locust bean gum and agar-agar.

A preferred salt for use in the vegan simulated egg white compositions of the invention is a black salt such as Kala Namak.

Vegan Simulated Egg Yolk

The vegan simulated egg yolk compositions of the invention generally have the following amounts of ingredients: from approximately 80 to 390 ml water, from approximately 2 to 10 g fungi derivative, from approximately 1 to 6 g thickener, from approximately 0.5 to 3 g salt, and from approximately 0.2 to 0.9 g coloring agent.

Precise amounts of each ingredient are not required, so long as the resulting egg yolk composition has an appearance, smell, feel, and taste approximating a animal-derived egg yolk.

The ingredients for the vegan simulated egg yolk composition of the invention are combined at room temperature, using a standard kitchen blender, and blended until homogeneous. The resulting blend may be degassed by letting the mixture sit for two to twelve hours to minimize air bubbles in the solution.

The vegan egg yolk compositions of the invention are frozen until solidified at temperatures of 0° Farenheit (“F”) (−17° Celsius) or lower, and subsequently spherified, for later use in a vegan whole egg composition, such as a vegan fried egg. The vegan simulated egg yolk, may be frozen in any shape desired, preferably in the shape approximating an unbroken, chicken-derived egg yolk, for use in a vegan fried egg.

Any volume of vegan simulated egg yolk may be spherified, using known methods, for example, by introduction into a calcium chloride solution bath containing 5 grams of calcium chloride per 500 ml of water, and by very gently stirring for up to three minutes, to make sure the calcium chloride solution contacts all the surface area of the yolk, until a thin film or “skin” is formed around the vegan simulated egg yolk. This procedure is then followed by rinsing the spherified yolk in cold tap water or distilled water bath to stop the chemical reaction which forms the skin.

In one embodiment, to facilitate production of large numbers of the compositions of the invention, the simulated egg yolk is not frozen, but is poured into multiple disk-shaped molds that are permeable to calcium chloride, such that a skin forms around the yolk. The molds containing the unfrozen simulated egg yolk are submerged in a calcium chloride solution bath as described above, for spherification.

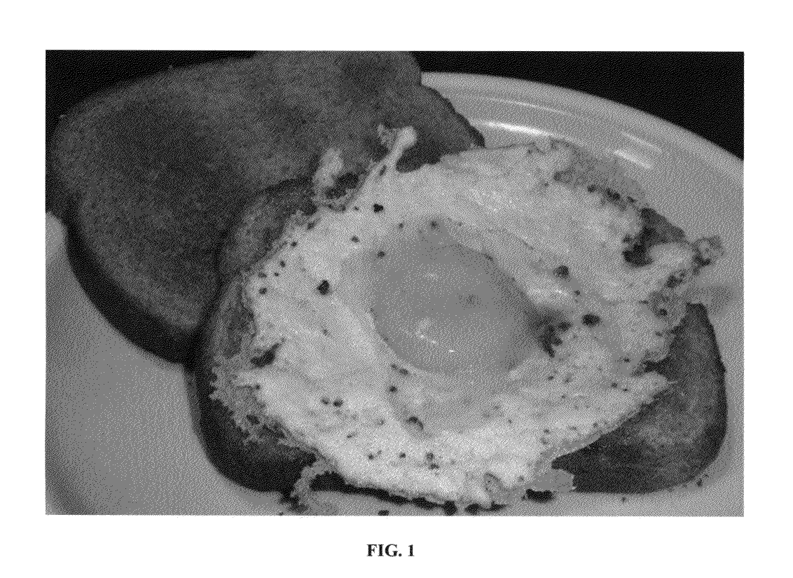

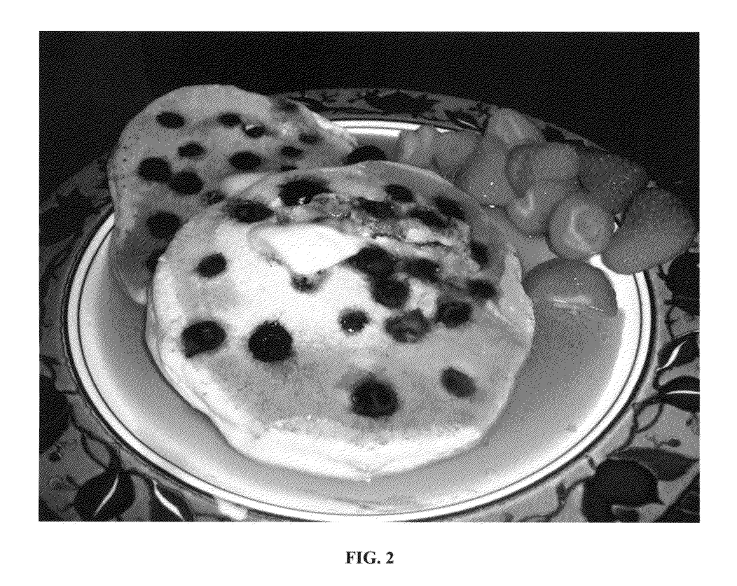

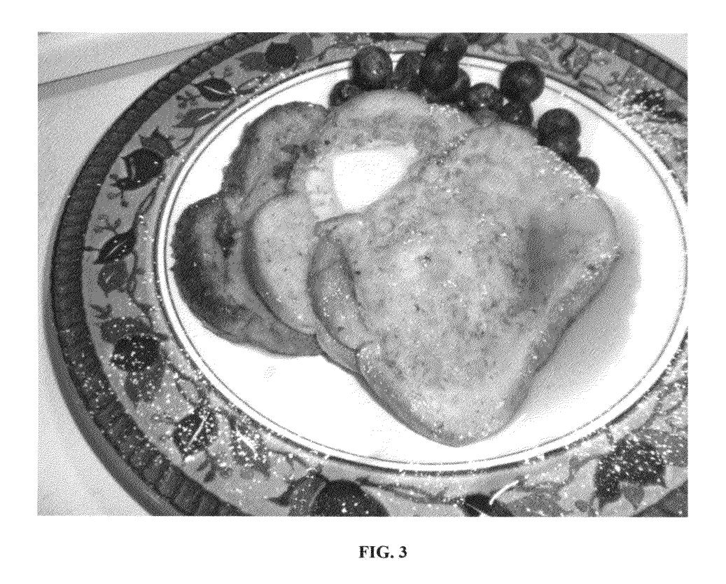

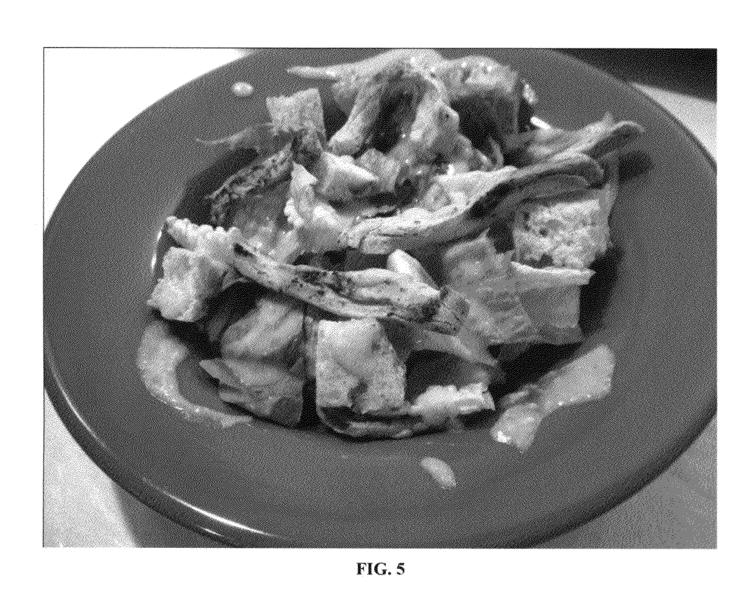

The resulting spherified, vegan simulated egg yolk or unspherified, vegan simulated egg yolk, is then ready to be consumed, heated, refrigerated, frozen and/or packaged for consumer use, and may be subject to cooking and/or baking in recipes that require egg yolks or whole eggs. The vegan simulated egg yolk may, in certain circumstances, be a substitute for whole chicken eggs or chicken egg yolks, and cooked in temperatures recited in the recipes. Suitability of the compositions of the invention to substitute for animal-derived egg ingredients in recipes may be determined by “trial and error.” For example, the vegan egg yolk has been successfully incorporated into a variety of recipes that require chicken eggs, such as the vegan simulated compositions of the invention depicted in FIGS. 1 through 7. FIG. 1 depicts a vegan fried whole egg composition of the invention. Other compositions, such as the vegan egg yolk-containing vegan blueberry pancakes of FIG. 2, vegan french toast of FIG. 3, and vegan salad dressing of FIG. 5, were produced by substituting a quantity of vegan simulated egg yolk approximating the amount of a chicken-derived egg yolk for each such yolk recited in a cooking recipe, or as desired.

It is not necessary to cook the vegan simulated egg yolk compositions of the invention before consumption. For example, the vegan simulated egg yolk is not cooked for use in the salad dressing of FIG. 5. However, the vegan egg yolk compositions of the invention may be heated to from approximately 120 to 160° F.

Vegan Simulated Egg White

The vegan simulated egg white composition of the invention generally has the following amounts of ingredients: from approximately 1.2 to 8.0 ml of water, from approximately 80 to 320 g non-animal derived protein based solid, from approximately 0.7 to 3.4 g fungi derivative, from approximately 0.2 to 1.2 g thickener and from approximately 0.8 to 4.2 g salt.

Precise amounts of each ingredient are not required, so long as the resulting vegan egg white composition has an appearance, smell, feel, and taste approximating an animal-derived egg white, such as a chicken egg white.

The ingredients for the vegan simulated egg white composition of the invention are combined at room temperature, using a standard kitchen blender, and blended until homogeneous.

Preferably, the vegan simulated egg white composition of the invention is prepared as described above, and is then placed in a heating/molding device under pressure, such as a tortilla press, for several minutes at 200-400° F., sufficient to form and cook the vegan simulated egg white such that it obtains an appearance that mimics the cooked white of an animal-derived egg, and possesses a solid, flexible texture. The thickness of the resulting egg white may be modified by using more or less pressure during pressing and cooking.

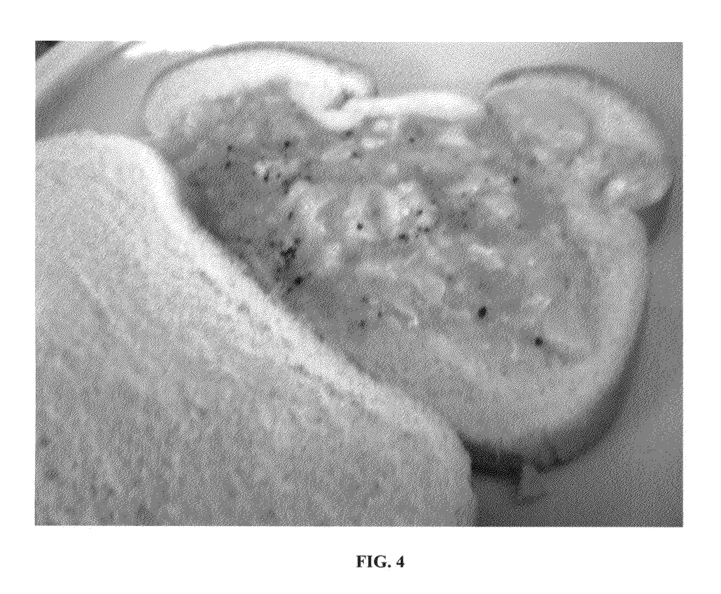

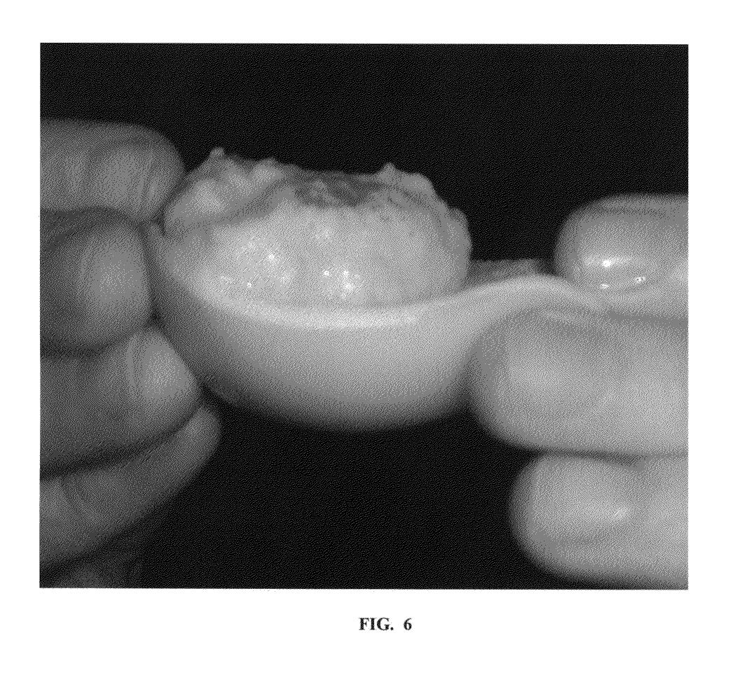

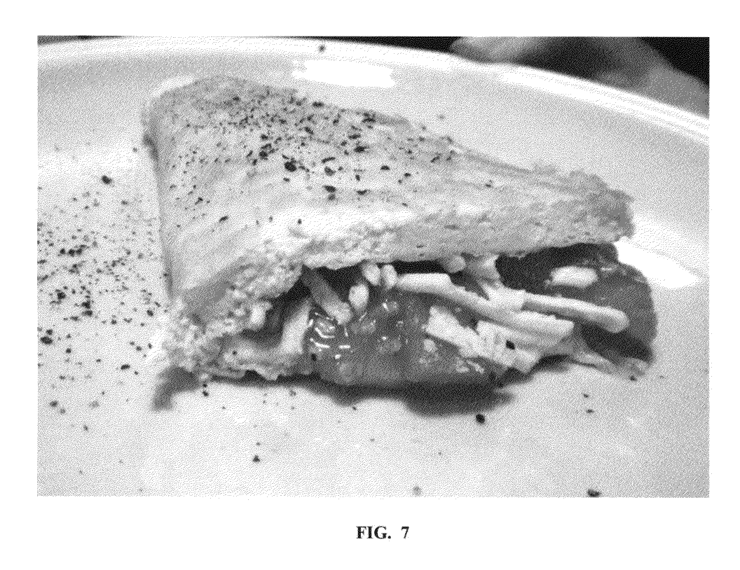

The resulting egg white composition is then refrigerated, frozen or packaged for consumer use, or may be used to produce the vegan simulated whole egg compositions of the invention, such as the vegan fried egg of FIG. 1, vegan scrambled eggs of FIG. 4, the omelette of FIG. 7, or, slightly modified to produce the vegan deviled egg of FIG. 6.

A vegan deviled egg is prepared, by using the simulated vegan egg white composition of the invention mixed with agar-agar for the white portion of the deviled egg, as follows. After the vegan simulated egg white is prepared as described above, agar-agar powder is then dissolved in water in the ratio of approximately 1 gm of agar-agar to approximately 100 ml of water. The agar-agar is slowly stirred into water at just under the boiling point of water, around 200° F., for two minutes, and is taken off the heat to cool to approximately 100° F. At this time, the agar-agar is blended into the vegan simulated egg white in an amount of from approximately 30% to 90%, and then chilled in a mold for several hours, until solid and flexible. Agar-agar is a gelatin substitute derived from a polysaccharide that accumulates in the cell walls of agarophyte red algae primarily Gelidium and Gracilara, or seaweed (Sphaerococcus euchema). Chemically, agar-agar is a polymer made up of subunits of the sugar galactose. It is available in flake or powder form. The yolk filling part of the deviled egg is made with the vegan simulated egg yolk composition of the invention, replacing egg yolk as recited in a typical deviled egg recipe, and combined with typical ingredients, such as vegan mayonnaise, yellow mustard and seasonings.

A vegan omelette is prepared by utilizing the vegan simulated egg white of the invention. The cooked, vegan simulated egg white is filled with omelette ingredients of choice such as onions, mushrooms, etc, folded over into a standard omelette shape and may be fried further before consumption.

Vegan Whole Egg

The vegan simulated whole egg composition of the invention consists of the vegan simulated egg yolk and vegan simulated egg white compositions of the invention, optionally joined with a binding agent.

In one embodiment, which mimics a fried chicken-derived egg, the spherified vegan simulated egg yolk is placed in the center of the simulated egg white, which has had a depression generally of the shape of the simulated egg yolk, formed into the central area of the white to receive the simulated yolk.

The simulated egg yolk and white compositions may be joined with an edible vegan material such as agar-agar/water mixture or konjac flour/water mixture, to enhance the “true egg” appearance of the whole egg combination. In one embodiment, the vegan simulated egg yolk is joined to the vegan simulated egg white by placing an amount of agar-agar solution into a depression molded into the white. Then the simulated egg yolk is deposited on top of the agar-agar and cooled for several hours.

The agar-agar powder is dissolved in water in the ratio of approximately 1 gm of agar-agar to approximately 100 ml of water. The agar-agar is slowly stirred into water at just under the boiling point of water, around 200° F. for two minutes, and is taken off the heat to cool to approximately 100° F. At this time, the agar-agar, still in liquid form is ready to be introduced into the previously described depression in the egg white prior to depositing the egg yolk on top of the still liquid agar-agar/water solution. The whole egg is then cooled for several hours until the agar-agar solution sets. Alternatively, the agar-agar in liquid form is poured over the surface of the egg yolk/egg white combination to keep the egg yolk in place. This is then placed in refrigeration to cool and set for two hours.

FIG. 1 is a photograph depicting an embodiment of the invention consisting of a vegan simulated whole egg, that has been fried.

The vegan fried whole egg composition need not be cooked before consuming, but may be heated, for example by frying the combined simulated egg yolk and egg white in a pan over heat, using a suitable cooking medium such as oil, vegan margarine or other substitute, or by heating in a microwave or other device, until a desired temperature and/or browning is obtained.

In another vegan whole fried egg embodiment, the ingredients comprising the vegan egg yolk and vegan egg white can be combined to provide a vegan “egg patty,” for example, for use in an egg sandwich, by mixing the previously described unfrozen, spherified, vegan egg yolk with the previously described uncooked vegan egg white in equal volumes. The mixture is then heated in a pressure heating device, of desired shape, to form a vegan whole fried egg patty.

For commercial purposes, the simulated egg yolk and egg white compositions of the invention may be prepared in a commercial kitchen using batch mixers and molds.

### ADVANTAGES OF THE INVENTION

The vegan egg compositions of the invention provide vegan simulated egg products to individuals, such as those needing to lower cholesterol intake, those with egg allergies, vegetarians and vegans, and those who have ethical/moral concerns about consuming animal-derived egg products. In particular, the vegan egg compositions of the invention provide an egg replacement that is palatable, closely mimicking the appearance, texture, smell, taste and protein and vitamin content of chicken-derived eggs.

The vegan egg yolk or whites of the invention may be used in place of animal-derived eggs in recipes including, but not limited to, french toast, scrambled eggs, sous vide eggs, toad in the hole, deviled eggs, egg nog, egg sandwiches, omelettes, etc.

The simulated egg products of the invention also reduce the risk of potential bacterial contamination that occurs in animal-derived eggs, from organisms such as Salmonella, Listeria, E.coli O157, Campylobacter and Clostridium perfringens.

Additional advantages of the invention include the ease of preparation and inexpensive, readily available ingredients, that are FDA approved.

It is to be understood, that the above embodiments are illustrative, and not restrictive. The scope of the invention should be determined with respect to the scope of the appended claims, along with their full scope of equivalents.

I claim:

1. A vegan simulated whole egg composition comprising a vegan simulated egg yolk composition having the sensory properties of an animal-derived egg yolk and a vegan simulated egg white composition having the sensory properties of an animal-derived egg white.

2. The vegan simulated whole egg composition of claim 1 having the approximate protein and vitamin content of a chicken-derived egg.

3. A vegan simulated egg yolk composition having the sensory properties of an animal-derived egg yolk.

4. The vegan simulated egg yolk composition of claim 3 comprising water, a fungi derivative, a thickening agent, a salt and a coloring agent.

5. The vegan simulated egg yolk composition of claim 4 wherein said fungi derivative is nutritional yeast flakes, said thickening agent is sodium alginate, said salt is a black salt, and said coloring agent is beta carotene.

6. A vegan simulated egg white composition having the sensory properties of an animal-derived egg white.

7. The vegan simulated egg white composition of claim 6 comprising a non-animal protein-based solid, a fungi derivative, a salt, and a thickening agent.

8. The vegan simulated egg white composition of claim 7 wherein said non-animal protein-based solid is legume-based, said fungi derivative is nutritional yeast flakes, said salt is a black salt, and said thickening agent is konjac powder.

9. A method for producing the vegan simulated egg yolk composition of claim 3, comprising combining until well mixed water, a fungi derivative, a thickening agent, a salt and a coloring agent.

10. The method of claim 9, wherein said water is present in a percentage weight of the total composition of from approximately 80% to 96%; said fungi derivative is present in a percentage weight of the total composition of from approximately 1.0 to 4.5%, said thickening agent is present in a percentage weight of the total composition of from approximately 0.1 to 3.3%, said salt is present in a percentage weight of the total composition of from approximately 0.3 to 3.5% and said coloring agent is present in a percentage weight of the total composition of from approximately 0.2 to 1.3%.

11. The method of claim 10 wherein said fungi derivative is nutritional yeast flakes, said thickening agent is sodium alginate, said salt is a black salt and said coloring agent is beta carotene powder.

12. The vegan simulated egg yolk composition produced by the method of claim 9.

13. A method for producing the vegan simulated egg white composition of claim 6, comprising combining until well mixed a non-animal protein based solid, a fungi derivative, a salt, and a thickener.

14. The method of claim 13, wherein said non-animal protein-based solid is present in a percentage weight of the total composition of from approximately 70.0 to 96.0%, said fungi derivative is present in a percentage weight of the total composition of from approximately 0.3 to 3.0%, said salt is present in a percentage weight of the total composition of from approximately 0.4 to 4.0% and said thickener is present in a percentage weight of the total composition of from approximately 0.4 to 3.0%.

15. The method of claim 14, wherein said non-animal protein-based solid is soybean tofu, said fungi derivative is nutritional yeast flakes, said salt is a black salt and said thickener is konjac flour.

16. The vegan simulated egg white composition produced by the method of claim 13.

17. A method of preparing the vegan simulated whole egg composition of claim 1, comprising preparing a spherified vegan simulated egg yolk and a vegan simulated egg white, and associating the egg yolk and egg white.

18. The vegan simulated whole egg composition of claim 17 further comprising adding a binder to join the simulated egg yolk with the simulated egg white.

19. The vegan simulated whole egg composition of claim 18 wherein said binder is selected from the group consisting of agar-agar, xanthum gum, carrageenan, methylcellulose, and locust bean gum.

20. The vegan simulated whole egg composition obtained by the method of claim 17.
